(19) United States
(12) Patent Application Publication
(10) Pub. No.: US 2013/0192085 A1
(43) Pub. Date: Aug. 1, 2013

(54) WASHER DRYER WITH A TEMPERATURE SENSOR AND PROCESS FOR ITS OPERATION

(71) Applicants: Harald Moschütz, Grossbeeren (DE); Vladimir Proseanic, West Bloomfield, MI (US); Svetlana Visnepolschi, West Boomfield, MI (US)

(72) Inventors: Harald Moschütz, Grossbeeren (DE); Vladimir Proseanic, West Bloomfield, MI (US); Svetlana Visnepolschi, West Boomfield, MI (US)

(73) Assignee: BSH HOME APPLIANCES CORPORATION, Irvine, CA (US)

(21) Appl. No.: 13/360,897

(22) Filed: Jan. 30, 2012

(51) Int. Cl. F26B 21/06; F26B 3/02

(52) U.S. Cl. 34/491; 34/73

(57) ABSTRACT

A washer-dryer including a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air exiting the drum, and at least one temperature sensor, wherein at least a part of a surface of the temperature sensor is formed from a hydrophobic material, and a method for operating the washer-dryer.

### BACKGROUND OF THE INVENTION

The present invention relates to a washer-dryer with a temperature sensor and a preferred method for its operation. The invention relates in particular to a washer-dryer including a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air exiting the drum, and a temperature sensor, as well as a preferred method for its operation.

Drum washing machines are popular, due to their water saving ability and avoidance of damage to the laundry processed thereby. In the past, washer-dryers, i.e., drum washing machines with drying functions, have acquired a considerable market share. Washer-dryers are popular because they combine in a compact manner the functions of a washing machine and a dryer. Moreover, a washer-dryer is already provided with a water supply access, such that water can be used not only for washing laundry, but also for further treatment steps. When drying, a such a drum washer-dryer usually takes in air through a fan set on an outside of a tub containing the drum, heats the air with an air heater, and then transfers the heated air to the tub and the inside of the drum. There, the heated air exchanges heat with the water contained in the laundry and takes moisture from the wet laundry. The moisture is then condensed in a condensing unit mounted on an outer side of the tub, and the condensate thus formed drained out of the washing machine.

In general, washing machines with drying functions dry the laundry at substantially constant temperatures and in preset periods of time. Such a method may however result, on one hand, overdrying the laundry when the amount of laundry to be dried is too small and, on the other hand, underdrying the laundry when the amount of laundry is too large. To overcome these unwanted results, temperature sensors and/or humidity sensors disposed inside the machine may be used to detect the temperature and/or humidity. The degree of dryness can then be determined based on the sensor signals and, as a result, a drying process can be controlled with relative accuracy.

As an example, document GB 2 082 742 A discloses a dryer which controls the drying time according to the internal temperature change rate in combination with a consideration of the type of clothes being washed and predetermined degree of dryness.

Document CN 1 503 864 A discloses a control unit for detecting the dryness in an air exhaust dryer based on the signals detected by a humidity detection unit and a temperature detection unit. The drying process can thereby be controlled.

Document CN 1 746 379 A discloses a drum washing machine with a drying function which has an upper temperature sensor and a lower temperature sensor mounted respectively on an upper end and a lower end of a vertical part of a hot air circulating pipe, and which has a control unit that determines a degree of dryness reached, based on the temperature difference detected between the upper and lower temperature sensors, and thereby controls the drying process.

Document CN 1 611 659 A discloses a drum washing machine system control device, which determines the load of the laundry to be dried according to data obtained by a humidity sensor set on a condensing pipe, and a drying device for drum washing machines which adjusts the temperature of a heater based on a laundry load, and a control method therefor.

Document WO 2007/138019 A1 discloses a drum washing machine with a drying program and a control method therefor. The washing machine comprises a tub to hold water; a drum rotatable set in the tub; a heating drying tunnel configured outside said tub; a first temperature detection unit set in the said tub; and a system control unit which controls the drying program based on the signal fed back from the first temperature detection unit.

Documents WO 2009/130145 A1 and US 2011/0030239 A1 each disclose a household appliance for drying a laundry item, the household appliance comprising a treatment chamber to receive the laundry item; a closed process air circuit to feed process air through the treatment chamber, the closed process air circuit comprising inter alia: a blower to move the process air; a condenser to condense out moisture carried in the process air; a heater to heat the process air; a first measurement device to determine a temperature of the process air when the process air enters the treatment chamber to provide a first measurement signal; and a controller to control the blower and the heater as a function of the first measurement signal. According to the only Figure, a number of temperature sensors on the process air duct or the cooling air duct can be used to control the drying process with redundancy and thus with a particularly high level of stability.

The cleaning of a temperature sensor from fluff, also called “lint”, and inorganic deposits poses a serious problem in that an agglomeration of fluff and inorganic deposits which might even result in limestone may interfere with the proper functioning of the washer-dryer. It has hence been known to clean this temperature sensor, including an NTC (Negative Temperature Coefficient) sensor, by means of a special rinsing process. This rinsing process consumes however up to about 6 liters (about 1.6 US gal.) of water. Such excessive water consumption should be avoided for economic and ecologic reasons.

Moreover, the presence of water on the sensor may cause faulty temperature indications. However, if an accurate temperature indication of the hot and humid process air is not obtained, proper functioning of the washer-dryer in a drying phase may not be assured.

Fluff accumulation and inorganic deposit formation is important in washer-dryers with an air-air heat exchanger, since much fluff usually accumulates on the heat exchanger. As regards the temperature sensor, this fluff will also disturb the correct temperature measurement of the temperature of the process air and thus the proper functioning of the washer-dryer. Fluff accumulation will be exacerbated if water is present on the surface of the temperature sensor. Another problem that might disturb the proper functioning of the sensor and thus a safe and reliable drying phase is due to the fact that sometimes water drops are splashed against the temperature sensor, causing a wrong temperature measurement. Finally, water evaporation at the surface of the temperature sensor can contribute to the formation of inorganic deposits.

The present use of temperature sensors and their respective cleaning processes do not ensure a proper cleaning of the temperature sensors, especially over a long service life.

### SUMMARY OF THE INVENTION

It is accordingly an object of the present invention to provide a washer-dryer with a temperature sensor that is less effected by the presence of water, inorganic substances and/or fluff and thus enhances reliable and safe operation of the washer-dryer especially during the drying phase, and of a corresponding method for its operation.

In accordance with the present invention, this object is achieved by a washer-dryer and a method for its operation with the features of the respective independent claims. Preferred embodiments of the invention are detailed in dependent claims. Preferred embodiments of the washer-dryer correspond to preferred embodiments of the method, even if they are not explained herein in detail.

The invention thus relates to a washer-dryer having a tub, a drum mounted in the tub to be rotatable around an essentially horizontal axis for receiving laundry items, a process air circuit comprising an air heater and a blower to heat and circulate the heated air through the drum, and a heat exchanger to condense moisture from the process air exiting the drum. The washer-dryer includes at least one temperature sensor having a surface formed at least partially from a hydrophobic material.

The hydrophobic material is not particularly limited as long as it will repel water while retaining a sufficient heat transfer capability to assure proper functioning of the sensor.

In a preferred embodiment of the washer-dryer, the temperature sensor has an elongate body and a temperature sensitive tip. More preferably, at least one of the the elongate body and the temperature sensitive tip includes a hydrophobic surface layer containing the hydrophobic material and/or a nanomaterial wherein nanoparticles render the surface hydrophobic.

In a further preferred embodiment, the elongate body is made of a hydrophobic polymer material, for example a fluorine containing polymer and/or a nanomaterial wherein nanoparticles render the surface hydrophobic.

“Elongate body” as used herein may also be termed “housing”.

Preferably, the hydrophobic material contains or consists of fluorine containing organic polymer. More preferably, the fluorine containing organic polymer is selected from the group consisting of polyvinylfluoride, polyvinylidene fluoride, po tetrafluoroethylene, polychlorotrifluoroethylene, perfluoroalkoxy polymer, fluorinated ethylene-propylen copolymers, po ethylenetetrafluoroethylene, po ethylenechlorotrifluoroethylene, perfluoropolyesther, perfluoropolyoxetane, and any mixture thereof.

In the fluorine containing organic polymer, the fluorine content is preferably higher than about 30 weight %, and more preferably higher than about 50 weight %, based on the weight of the fluorine containing organic polymer.

One example is a fluoroelastomer copolymer based on hexafluoropropylene and vinylidenefluoride which is available under the trade name TECNOFLON® from Solvay Solexis.

The hydrophobic material, in particular a fluorine containing polymer, can be applied to the sensor by coating a surface of the sensor with a highly hydrophobic paint or by applying a shrinking hose or cover made of the hydrophobic material. Furthermore, the sensor housing, which is usually stainless steel, can be formed from a hydrophobic plastic material, preferably a hydrophobic plastic material containing a fluorine containing polymer.

In a preferred embodiment of the washer-dryer, the temperature sensor is located in a connecting part extending between the tub and the heat exchanger. Here it is more preferable that the connecting part is a flexible hose connecting the tub with the heat exchanger. Preferably, the temperature sensor is situated in a lower half of the connecting part.

In the washer-dryer of the present invention, the temperature sensor is preferably an NTC temperature sensor. NTC temperature sensors are preferred since they allow enhancing the accuracy of the temperature determination.

The washer-dryer may include two or more temperature sensors to improve its operation. Preferably, the washer-dryer of the present invention includes at least one temperature sensor located in the connecting part between the tub and the heat exchanger (which also may be referred to in the following as “first temperature sensor”). More preferably, the washer-dryer also includes a second temperature sensor which may be placed in the process air circuit at a location in front of an entrance into the interior of the drum, for example between the air heater and the sleeve.

In a preferred embodiment of the washer-dryer, the first temperature sensor is immersible in the aqueous liquid when the washer-dryer is operated in at least one of a washing phase and a rinsing phase.

Accordingly, fluff and deposits of inorganic salts from a previous drying phase can be removed in a washing or rinsing phase preceding the next drying phase. Thus, the formation of fluff agglomerates or limestone might be avoided. As a result, the first temperature sensor can function properly and the washer-dryer of the present invention can also function properly.

The connecting part between the tub and the heat exchanger which is usually present in the washer-dryer of the present invention can be a part which is integrally formed into the body of the heat exchanger or the tub. Alternatively, it can be formed as a separate piece which is placed between the tub and the heat exchanger. In a particular preferred embodiment, the connecting part is a flexible hose connecting the tub with the heat exchanger.

The first temperature sensor may in principle be situated at various locations within the connecting part. It is preferred that the first temperature sensor is located in a lower portion of the connecting part. “Location in a lower portion” means here in particular that a tip of the first temperature sensor is at least partially, preferably totally located in the lower half of the connecting part.

In this embodiment, cleaning the first temperature sensor in a washing or rinsing phase can be achieved with a lower level of the aqueous liquid in the tub, the connecting part, or both. The location in the lower half of the connecting part allows placing the connecting part higher than in the case where the first temperature sensor is placed in the upper half of the connecting part without negatively affecting the cleaning process.

It is moreover preferred that the temperature sensor in particular the first temperature sensor, is inclined toward the tub. For example, if the temperature is located in an essentially horizontal connecting part between the tub and the heat exchanger, “inclined toward the tub” means that a tip of the sensor is closer to the tub than a body of the sensor.

This allows improved cleaning of the temperature sensor. For example, an inclination of the NTC toward the air flow assists movement of water drops on the NTC surface from its top to the bottom. The effect is more pronounced when the first temperature sensor is inclined toward the tub by an angle α in the range of from about 5° to about 30°, more preferably in the range of from about 10° to about 25°, relative to a vertical axis. “Vertical axis” as used herein usually refers to an axis that is perpendicular to a ground plate of the washer-dryer, the ground level of the room where the washer-dryer is to be placed, or both.

Preferably, in the washer-dryer of the present invention, the first temperature sensor forms an angle β less than about 60° with a horizontal plane through the center of the connecting part. The horizontal plane is in general perpendicular to the vertical axis mentioned above.

The connecting part comprises preferably several folds and the first temperature sensor is preferably placed in or on one of these folds. Preferably, the connecting part is formed from flexible plastic material.

The washer-dryer of the present invention includes a heat exchanger. In principle, a heat exchanger might be realized by using relatively cold water from the water supply or another source to condense the moisture carried by the process air in a washer-dryer. This embodiment can be realized fairly easily, but uses a generally excessive amount of water and is thus preferably avoided.

It is preferred according to the present invention to us an indirectly cooled condenser, in which there is no direct contact between the warm and humid process air to be cooled and the cooling agent used. An indirectly cooled condenser can be realized for example as an air-cooled condenser, i.e. an air-air heat exchanger, with the air serving as the cooling agent being taken usually from the room wherein the washer-dryer is placed. The used air is usually fed back to this room again after it has been used in the cooling step.

The indirectly cooled condenser may be also embodied as a heat sink of a heat pump in the washer-dryer. The heat pump takes in heat from the hot and humid process air in the condenser, pumps this heat to the air heater in the process air circuit and discharges it back to the process air. Such a heat pump can be embodied as a compressor heat pump, in which a cooling agent circulates which is cyclically evaporated in the condenser as it absorbs heat from the air flow and is condensed in the condenser as it emits heat to the air flow. The heat pump may also be operable by means of a reversible sorption process, a regenerative gas circuit process or the Peltier effect.

In a particularly preferred embodiment of the present invention, the heat-exchanger is an air-to-air heat exchanger, also called an air-air heat exchanger.

In still a further preferred embodiment of the present washer-dryer, the first temperature sensor is closer to the tub than to the heat exchanger. This allows the first temperature sensor, for example an NTC temperature sensor to be assembled close to vibrations generated as a result of the washing and spinning processes which provide forces hindering any adhesion at the temperature sensor surface and can assist the removal of water drops.

Preferably, the temperature sensor is placed in the process air circuit, for example the connecting part, in a manner whereby it can measure the temperature in or close to the center of the process air flow. This allows a more accurate control of the drying phase. Thus, the temperature sensor is preferably arranged such that it may be in contact with the center of the process air flow. In addition, the process air circuit, for example the connecting part between tub and heat exchanger, may be provided with a guiding arrangement that guides the process air flow towards the temperature sensor.

In general, a washer-dryer is connected to a water supply system which provides to guide water through a detergent rinsing shell such that portions of detergent or auxiliaries can be flushed into the tub. Such a water supply system might involve a bifurcation of the heat exchanger such that water from the water supply system might be used for the rinsing device of the heat exchanger and/or as cooling liquid itself in the heat exchanger.

In the case of an indirectly cooled condenser, the washer-dryer of the present invention can thus contain a rinsing device for the condenser, which cleans the heat exchanger. In such an embodiment, the rinsing device can be used to additionally clean the temperature sensor. To this end the rinsing device might be connected to the aforementioned water supply. Water may be used as an aqueous cleaning fluid. In that case it might be useful to use the water from the water supply. Ingredients may be supplied to the cleaning water that assist in the cleaning process. In a preferred process according to the present invention, the aqueous cleaning fluid contains ingredients that allow dissolving inorganic deposits on the sensor. A useful ingredient may be an acid that assists in dissolving calcium carbonate.

In general, a washer-dryer may include a suds discharge system at its base including a drain valve and a suds pump and any necessary piping. Furthermore, a washer-dryer in general contains laundry agitators and/or scooping devices. A plurality of such laundry agitators and/or scooping devices, in particular, three or four such devices, is preferred. The laundry agitator may be cast into the drum as an integral component or inserted into the drum as an additional component. Such a structure configuration is representative of a plurality of embodiments, which may include an arrangement of particular fins or be formed as a helical wound configuration of an interior part of the drum.

A washer-dryer generally has a switching arrangement for rotating and stopping the drum. Moreover, a washer-dryer according to the present invention preferably includes a sensor for determining a quantity of liquid disposed in the suds container. The sensor is usually placed in a lower part of the tub. A conventional sensor for determining the water level can be used as a sensor for determining the quantity of liquid disposed in the tub, i.e. the suds container, the sensor signal of which is tracked during machine operation. Such a sensor generally measures a hydrostatic pressure p and/or a temporal gradient (Δp/Δt)₁ of the hydrostatic pressure p.

In addition, a washer-dryer in general contains a heater for the direct heating of an aqueous liquid, for example suds. This heater, termed herein “water heater”, is in general disposed in the tub below the drum.

The invention is moreover directed to a method for operating a washer-dryer having a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air coming out of the drum. The method includes the steps of evaluating temperature signals measured by a temperature sensor wherein at least a part of a surface of the temperature sensor contains a hydrophobic material; and controlling a drying phase by evaluating temperature signals measured by the temperature sensor. In this process the temperature sensor is preferably placed in between the tub and the heat exchanger.

In a preferred method of the present invention, the temperature sensor, preferably a first temperature sensor, is cleaned by an aqueous liquid coming from the tub, a rinsing device, or both. Preferably, this method is conducted under forced convection to increase a flow around the first temperature sensor. Forced convection that results in an increased turbulent flow around the first temperature sensor can be established by a specific rotation pattern of the drum such that the aqueous liquid in the tub is pushed toward, preferably back and forth in relation to, the first temperature sensor in the connecting part. As an alternative or in addition thereto the blower of the washer-dryer may be used to create a strong air flow which is directed to on the aqueous liquid and thus creates forced convection.

A specific cleaning phase can be defined within a washing or rinsing phase that is optimized to clean the first temperature sensor.

Cleaning can be preferably carried out in a wash or rinse phase where an imbalance in the load distribution gives rise to vibrations of the drum and the tub, respectively. This assists in the removal of fluff or inorganic deposits.

In a preferred process of the present invention, a drying phase is conducted by controlling the blower and the air heater such that a set maximum temperature Tₘₐₓ for the temperature of the warm air is not exceeded. In a preferred method of the present invention, the drum is rotated during the flushing phase to cause the sensor to vibrate. In this embodiment it is preferred that a connecting part between the tub and the heat exchanger is sufficient rigid to allow the transmission of vibrations of the tub. Moreover, the transmission of vibrations is more pronounced when the sensor is closer to the tub than to the heat exchanger. This allows the first temperature sensor, for example an NTC temperature sensor, to be assembled close to the moving oscillation system vibrations from the rotating drum which provide forces hindering any adhesion at the sensor surface and can assist the removal of water drops, fluff and inorganic deposits.

The invention has several advantages. The washer-dryer of the present invention is configured for operation with a temperature sensor that is resistant to water drops and fluff. The evaporation of water drops at the sensor surface, in particular at the surface of an NTC temperature sensor will be avoided. The temperature sensor can be easily cleaned from deposits of fluff or inorganic salts, for example during a washing and rinsing phase of the washer-dryer or by a separate cleaning process. Thus, in the washer-dryer of the present invention, the temperature sensor is configured to provide highly reliable signals regarding the temperature of the process air leaving the drum and the tub. As a result, the operation of the washer-dryer can be controlled more precisely. The risk of overheating the laundry items to be dried can be avoided. This is of particular advantage when sensitive laundry items such as wool, silk or lace are being dried.

Fluff accumulated on the first temperature sensor can be removed efficiently in a washing or rinsing process preceding the drying phase. Thus, for controlling the drying phase a freshly cleaned first temperature sensor can be used. As a result, the washer-dryer of the present invention allows precise and safe drying phases. These advantages can be achieved in embodiments of the invention without an increased water level and without additional water consumption. The washer-dryer can thus be operated in embodiments not only safely, but also without the need of using undesirable amounts of water.

### BRIEF DESCRIPTION OF THE DRAWINGS

FIG. 1 is a diagrammatic view of a temperature sensor according to a preferred embodiment of the present invention.

FIG. 2 is a diagrammatic view of a washer-dryer according to a first preferred embodiment of the present invention.

FIG. 3 is an side, partial cutaway view of a connecting part between the tub and the heat exchanger in a washer-dryer according to the present invention.

FIG. 4 is a diagrammatic view of a washer-dryer according to a second preferred embodiment of the present invention.

### DESCRIPTION OF THE PREFERRED EMBODIMENTS

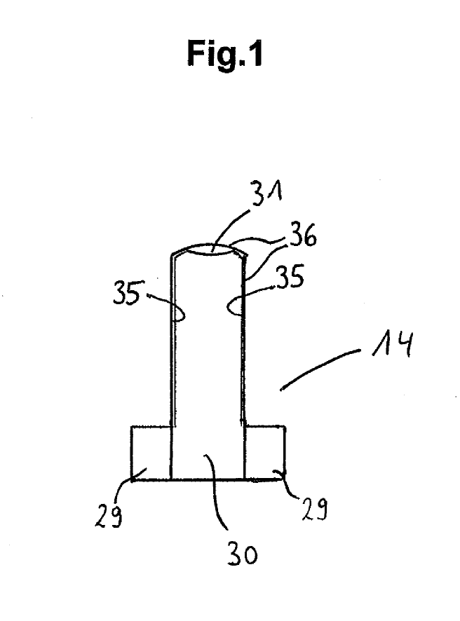

Turning now to the drawings and, more particularly to FIG. 1, a temperature sensor according to one embodiment of the present invention configured for carrying out the method of the present invention is illustrated. Other embodiments are conceivable.

With continued reference to FIG. 1, the temperature sensor 14 has an elongate body 30 that is covered by an hydrophobic layer 35 which includes a fluorine containing organic polymer. In this embodiment, a temperature sensitive tip 31 of sensor 14 is not covered with a hydrophobic layer. However, other embodiments are possible as long as the temperature sensor 14 can measure the temperature with sufficient accuracy.

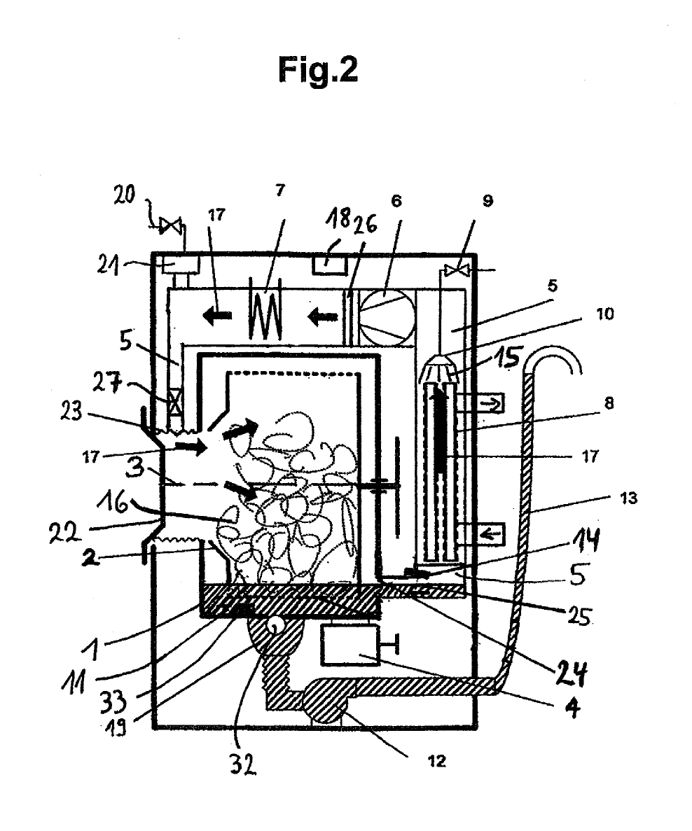

FIG. 2 shows a washer-dryer according to a first preferred embodiment in which the method of the present invention can be implemented. Other embodiments are conceivable. The washer-dryer of this embodiment includes a tub 1 (also to be referred to as “suds container”) and a drum 2 which is placed in the tub 1 such that it can be rotated around an essentially horizontal axis 3. Laundry items 16 are placed in the drum 2 for treatment. The tub 1 is connected by means of a flexible hose 25 as a connecting part to a heat exchanger 8 which is herein an air-air heat exchanger.

The tub 1 is connected to a pump 12 via a suds draining duct 19 which facilitates the discharge of an aqueous liquid 11, for example suds, from the tub 1. A waste water conduit 13 directs the aqueous liquid 11 out of the washer-dryer. The drum 2 is driven by a drive motor 4.

The drum 2 is filled through a door 22 which allows the access to the interior of the drum 2 with laundry 16 to be treated. In order to wash laundry 16 in the washer-dryer, the washer-dryer is connected to a water feed line 20. The water feed line 20 is connected to a detergent rinsing shell 21 from which detergent and auxiliary agents can be flushed into the tub 1 with the aid of water from the water feed line 20 to allow a washing process in the washer-dryer. In this embodiment, this is achieved through a part of the process air circuit 5 and a sleeve 23.

For drying wet laundry items in the drum 2 of the washer-dryer illustrated in FIG. 2, which operates according to the principle of circulating air, air heated by an air heater 7 (“process air”) is driven through the process air circuit 5 with the aid of a blower 6. Heated process air then enters the tub 1 and the drum 2, respectively, through the sleeve 23. The humid and warm process air resulting from the passage of the process air through the drum 2, where it has taken up moisture from the wet laundry items 16, arrives at a rear exit 24 of the tub 1 and thereafter at the heat exchanger 8. In the air-air heat exchanger 8, the process air is cooled with cold air and moisture contained in the process air condenses. The condensate may be collected in a condensate container (not shown) or may flow back to the tub 1 and finally to the suds draining duct 19 whereby it can be discharged through the waste water conduit 13. The dried air flows inside the process air circuit 5, is heated again by the air heater 7 and then introduced again via the sleeve 23 into the drum 2. Filled arrows 17 indicate the flow of the warm air. Short, unfilled and unnumbered arrows indicate the flow of the cooling air inside the air-air heat exchanger 8.

A sensor 14 is placed between the tub 1 and the air-air heat exchanger 8, preferably in a flexible hose 25, and is used to control a drying phase in the washer-dryer. The sensor 14 is here a first temperature sensor 14 and more particularly an NTC-type temperature sensor.

The washer-dryer shown in FIG. 2 is configured for flushing the heat exchanger 8 with an aqueous cleaning liquid 15. To that end, the washer-dryer of FIG. 2 has a rinsing device 10 disposed above the heat exchanger 8. Accordingly, the rinsing device 10 is configured for flushing both the air-air heat exchanger 8 and the sensor 14 with an aqueous cleaning liquid 15, for example, by spraying. Moreover, the rinsing device 10 in this embodiment is connected to a water supply system, for example, the water feed line 20, via a water valve 9. Thus, water from a water supply system can be used as the aqueous cleaning liquid 15. The aqueous cleaning liquid 15 may contain ingredients that assist in the cleaning process. In particular, the aqueous cleaning liquid 15 may contain ingredients that assist in the removal of inorganic deposits like limestone from the sensor 14. For example, an acid may be applied.

The use of a temperature sensor wherein at least a part of the surface of the temperature sensor is made of a hydrophobic material enhances the ability of the temperature sensor to be cleaned. Moreover, water is not retained on the sensor surface.

In order to allow a better control not only of a flushing phase, but also a drying phase in the washer-dryer, a second temperature sensor 27 is placed in the process air circuit 5 close to the door 22.

FIG. 2 also shows a control unit 18 which controls the operation of the washer-dryer based at least partially on the signals received from the first and second temperature sensor and in particular controls of the method of the present invention. The water valve 9, the air heater 7 and a water heater 32 are all controlled by the control unit 18 as a function of a pre-programmed workflow. The program may utilize a timer signal. Further, the program utilize signals based on sensed conditions or parameters such as the level of an aqueous liquid, for example the suds level, the suds temperature and the speed of the drum 2.

A drying phase is usually carried out by circulating process air repeatedly through the process air circuit 5 until a desired degree of dryness in the laundry items 16 is obtained. The washer-dryer of FIG. 2 provides enhanced precision in controlling the drying phase in that the drying phase is conducted by controlling the blower 6 and the air heater 7 such that a set maximum process air temperature Tₘₐₓ is not exceeded.

A hydrostatic pressure sensor 33 for measuring the hydrostatic pressure p in the suds container 1 is also provided.

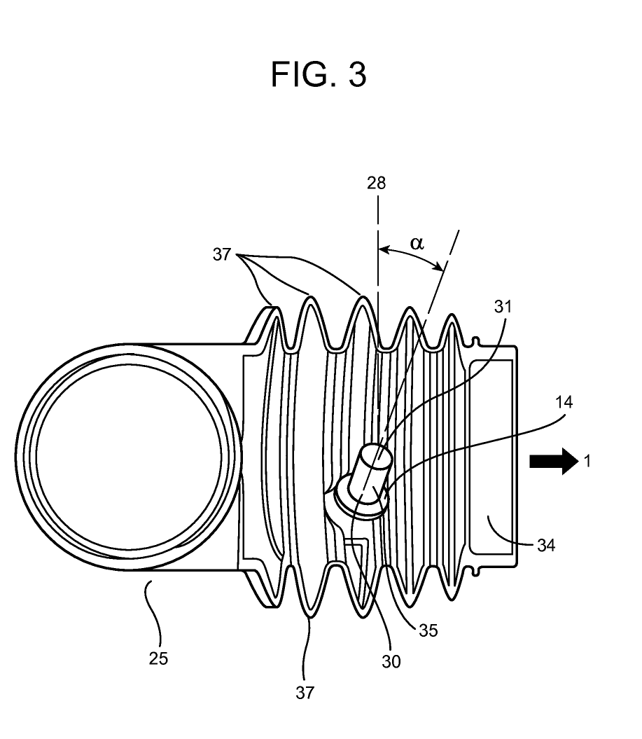

FIG. 3 shows an enlarged view of a connecting part extending between the tub and the heat exchanger. The connecting part may be a hose. In particular, a cut through a hose is shown such that the interior of the hose can be seen.

The first temperature sensor 14 shown herein is an NTC-type temperature sensor with an elongate body 30 and a temperature sensitive tip 31. The first temperature sensor 14 is located on a fold 35 in a lower half of the bellows-like flexible hose 25. The first temperature sensor 14 is inclined in the direction of the tub which is not shown here. However, an arrow indicates the direction to the tub 1. The first temperature sensor 14 is here inclined toward the tub 1 by an angle α in the range of from about 5° to about 30°, relative to a vertical axis 28.

The elongate body 30 includes a hydrophobic surface layer 35 consisting of a fluorine containing organic polymer.

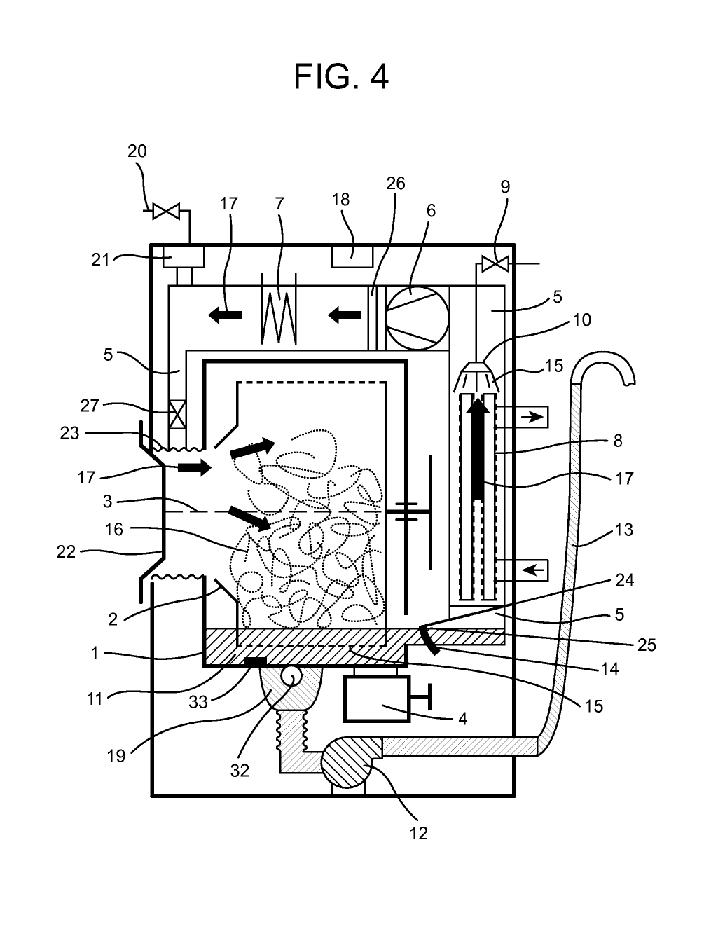

With reference to FIG. 4, a washer-dryer according to a second embodiment of the present invention configured for carrying out the method of the present invention is illustrated. Still further embodiments are conceivable.

The washer-dryer of this embodiment includes a tub 1 and a drum 2 which is placed in the tub 1 such that it can be rotated around an essentially horizontal axis 3. Laundry items are placed in the drum 2 for treatment. The tub 1 is connected to a heat exchanger 8 by a flexible hose 25 as connecting part. The heat exchanger 8 may be an air-air heat exchanger.

The tub 1 is connected to a pump 12 via a suds draining duct 19 which facilitates the discharge of an aqueous liquid 11, for example suds, from the tub 1. A waste water conduit 13 directs the aqueous liquid 11 out of the washer-dryer. The drum 2 is driven by a drive motor 4.

The drum 2 is filled through a door 22 that allows the access to the interior of the drum 2 with laundry 16 to be treated. In order to wash laundry 16 in the washer-dryer, the washer-dryer is connected to a water feed line 20. The water feed line 20 is connected to a detergent rinsing shell 21 from which detergent and auxiliary agents can be flushed into the tub 1 with the aid of water from the water feed line 20 to allow a washing process in the washer-dryer. In this embodiment, this is achieved through a part of the process air circuit 5 and a sleeve 23.

For drying wet laundry items in the drum 2 of the washer-dryer illustrated in FIG. 4, which operates according to the principle of circulating air, air heated by an air heater 7 (“process air”) is driven through the process air circuit 5 with the aid of a blower 6. Heated process air then enters the tub 1 and the drum 2, respectively, through the sleeve 23. The humid and warm process air resulting from the passage of the process air through the drum 2, where it has taken up moisture from the wet laundry items 16, arrives at a rear exit 24 of the tub 1 and thereafter at the heat exchanger 8. In the air-air heat exchanger 8, the process air is cooled with cold air and the moisture contained in the process air condenses. The condensate may be collected in a condensate container (not shown) or may flow back to the tub 1 and finally to the suds draining duct 19 whereby it can be discharged through the waste water conduit 13. The dried air flows inside the process air circuit 5, is heated again by the air heater 7 and then introduced again via the sleeve 23 into the drum 2. Filled arrows 17 indicate the flow of the warm air. Short, unfilled and unnumbered arrows indicate the flow of the cooling air inside the air-air heat exchanger 8.

In the embodiment shown in FIG. 4, a first temperature sensor 14 is placed in the flexible hose 25, such that the first temperature sensor 14 is allowed to be at least partially immersed in an aqueous liquid 11 contained in the tub 1 when the washer-dryer is operated in a washing or rinsing phase.

In the embodiment of the washer-dryer shown in FIG. 4, the first temperature sensor 14 is placed in the lower part of the flexible hose 25. Moreover, the first temperature sensor 14 is inclined toward the tub 1.

In order to allow a more precise control of a drying phase in the washer-dryer, a second temperature sensor 27 is placed in the process air circuit 5 close to the door 22.

The washer-dryer of FIG. 4 is configured for an operational method whereby a washing or rinsing phase involving an aqueous liquid 11 is conducted such that the first temperature sensor 14 is at least partially immersed in the aqueous liquid 11. Moreover, the washer-dryer is configured for conducting the method under forced convection to increase a flow around the first temperature sensor 14. This can be achieved by using the blower 7 during a washing or rinsing phase such that a strong flow of air is directed to the aqueous liquid 11 in the tub 1 which is then driven in the direction of the first temperature sensor 14.

A drying phase is usually carried out by circulating process air repeatedly through the process air circuit until a desired degree of dryness in the laundry items is obtained. The washer-dryer of FIG. 4 allows a precise control of the drying phase in that the drying phase is conducted by controlling the blower 6 and the air heater 7 such that a set maximum process air temperature Tₘₐₓ is not exceeded.

A sensor 33 for measuring the hydrostatic pressure p in the suds container 1 is also provided.

The washer-dryer of the embodiment of FIG. 4 has a rinsing device 10 for the heat exchanger 8 which can be connected to a water supply system such as the water feed line 20 via a water valve 9.

FIG. 4 shows also a control unit 18 which controls the operation of the washer-dryer based at least partially on signals received from the first and second temperature sensor. The water valve 9, the air heater 7 and a water heater 32 are all controlled by the control unit 18 as a function of a pre-programmed workflow. The program may utilize a timer signal. Further, the program may utilize signals based on sensed conditions such as the level of an aqueous liquid, for example the suds level, suds temperature and the speed of the drum 2.

What is claimed is:

1. A washer-dryer having a tub, a drum mounted in the tub to be rotatable around an essentially horizontal axis for receiving laundry items, a process air circuit comprising an air heater and a blower to heat and circulate the heated air through the drum, and a heat exchanger to condense moisture from the process air exiting the drum, the washer-dryer comprising at least one temperature sensor having a surface formed at least partially from a hydrophobic material.

2. A washer-dryer according to claim 1 wherein the temperature sensor has an elongate body and a temperature sensitive tip.

3. A washer-dryer according to claim 2 wherein at least one of the elongate body and the temperature sensitive tip includes a hydrophobic surface layer containing the hydrophobic material.

4. A washer-dryer according to claim 3 wherein the elongate body is formed from a hydrophobic polymer material.

5. A washer-dryer according to claim 1 wherein the hydrophobic material includes an organic fluorine containing polymer.

6. A washer-dryer according to claim 5 wherein the fluorine containing polymer is selected from the group consisting of polyvinylfluoride, polyvinylidene fluoride, po tetrafluoroethylene, polychlorotrifluoroethylene, perfluoroalkoxy polymer, fluorinated ethylene-propylen copolymers, po ethylenetetrafluoroethylene, po ethylenechlorotrifluoroethylene, perfluoropolyesther, perfluoropolyoxetane, and any mixture thereof.

7. A washer-dryer according to claim 1 wherein the temperature sensor is located in a connecting part extending between the tub and the heat exchanger.

8. A washer-dryer according to claim 7 wherein the connecting part is a flexible hose connecting the tub with the heat exchanger.

9. A washer-dryer according to claim 7 wherein the temperature sensor is situated in a lower half of the connecting part.

10. A washer-dryer according to claim 1 wherein the temperature sensor is an NTC temperature sensor.

11. A washer-dryer according to claim 1 wherein the temperature sensor is inclined towards the tub.

12. A washer-dryer according to claim 11 wherein the temperature sensor is inclined toward the tub at an angle α in a range of from about 5° to about 30°, relative to a vertical axis.

13. A washer-dryer according claim 1 and further comprising a heat exchanger that is an air-air heat exchanger.

14. A method for operating a washer-dryer having a tub, a drum mounted in the tub to be rotatable around an essentially horizontal axis for receiving laundry items, a process air circuit comprising an air heater and a blower to heat and circulate the heated air through the drum, and a heat exchanger to condense moisture from the process air exiting the drum, the method comprising the steps of:
evaluating temperature signals measured by a temperature sensor wherein at least a part of a surface of the temperature sensor contains a hydrophobic material; and
controlling a drying phase by evaluating temperature signals measured by the temperature sensor.

15. A method for operating a washer-dryer according to claim 14 and further comprising the step of cleaning the temperature sensor using at least one of an aqueous liquid exiting the tub and a rinsing device.
